(19) United States
(12) Patent Application Publication
(10) Pub. No.: US 2016/0341137 A1
(43) Pub. Date: Nov. 24, 2016

(54) APPARATUS FOR CONTROLLING ENGINE OF VEHICLE AND METHOD THEREOF

(71) Applicants: HYUNDAI MOTOR COMPANY, Seoul (KR); Kia Motors Corporation, Seoul (KR)

(72) Inventor: Tae Seong Lee, Suwon-si (KR)

(73) Assignees: HYUNDAI MOTOR COMPANY, Seoul (KR); KIA MOTORS CORPORATION, Seoul (KR)

(21) Appl. No.: 14/857,131

(22) Filed: Sep. 17, 2015

(30) Foreign Application Priority Data
May 21, 2015 (KR) 10-2015-0071080

(51) Int. Cl. F02D 41/00; F02M 26/52; F02D 41/38; F01N 3/20; F01N 3/08

(52) U.S. Cl. CPC F02D 41/0007; F01N 3/2066; F01N 3/0842; F01N 3/2006; F02D 41/3809; F02M 26/52

(57) ABSTRACT

An apparatus for controlling an engine of a vehicle according to the present disclosure may include: a common rail engine having a plurality of combustion chambers, and supplying driving torque by combustion of fuel injected to the combustion chambers; an EGR apparatus supplying exhaust gas to the combustion chambers by recirculating a part of exhaust gas exhausted from the combustion chambers; an SCR catalyst disposed at an exhaust pipe and purifying the exhaust gas exhausted from the combustion chambers; and a controller controlling control parameters of the common rail engine according to temperature of the SCR catalyst.

### CROSS-REFERENCE TO RELATED APPLICATION

This application claims the benefit of Korean Patent Application No. 10-2015-0071080, filed on May 21, 2015, which is hereby incorporated by reference in its entirety.

### FIELD

The present disclosure relates to an apparatus for controlling an engine of a vehicle and a method thereof. More particularly, the present disclosure relates to an apparatus for controlling an engine of a vehicle and a method that can improve fuel consumption and reduce an amount of exhaust gas such as nitrogen oxide.

### BACKGROUND

The statements in this section merely provide background information related to the present disclosure and may not constitute prior art.

Environmental regulations on noxious materials in exhaust gases from vehicles have been increasingly enhanced in many countries. Accordingly, vehicles are equipped with various types of catalyst devices for removing noxious materials such as NOx, CO, and THC contained in exhaust gases under those regulations on exhaust gases.

As examples of the various types of catalyst devices, a diesel oxidation catalyst (DOC), a diesel particulate filter (DPF), a lean NOx trap (LNT), and a selective catalytic reduction unit (SCR) are used.

An exhaust gas post-processing system, such as the DOC, the LNT, and the SCR, mounted for reducing noxious materials needs a basic temperature (activation temperature) for chemical reaction.

Generally, a temperature of exhaust gas in a cool state of the engine is low, and the exhaust gas post-processing system is not activated in the cool state. Therefore, a purification rate of exhaust gas by the exhaust gas post-processing system is decreased, and an amount of exhaust gas, such as nitrogen oxide, is increased

As such, a method that increases the exhaust gas recirculation (EGR) ratio is used in order to decrease the amount of exhaust gas. However, fuel consumption of a vehicle is deteriorated when the method is used.

### SUMMARY

The present disclosure provides an apparatus for controlling an engine of a vehicle that can improve fuel consumption of the vehicle and reduce an amount of exhaust gas when temperature of an exhaust gas post-processing unit does not reach an activation temperature.

An apparatus for controlling an engine of a vehicle according to an exemplary embodiment of the present disclosure may include: a common rail engine having a plurality of combustion chambers, and supplying driving torque by combustion of fuel injected to the combustion chambers; an EGR apparatus supplying exhaust gas to the combustion chambers by recirculating a part of exhaust gas exhausted from the combustion chambers; an SCR catalyst disposed at an exhaust pipe and purifying the exhaust gas exhausted from the combustion chambers; and a controller controlling control parameters of the common rail engine according to temperature of the SCR catalyst.

The controller may enter a catalyst activation combustion mode when the temperature of the SCR catalyst is greater than or equal to an activation temperature, and may enter a catalyst deactivation combustion mode when the temperature of the SCR catalyst is less than the activation temperature.

When the catalyst activation combustion mode is entered, the controller may advance timing of fuel injection into the combustion chamber, increase pressure of a common rail of the common rail engine, and decrease a recirculation amount of the exhaust gas by the EGR apparatus.

When the catalyst deactivation combustion mode is entered, the controller may retard timing of fuel injection into the combustion chamber, decrease pressure of a common rail of the common rail engine, and increase a recirculation amount of the exhaust gas by the EGR apparatus.

A method for controlling an engine of a vehicle according to another exemplary embodiment of the present disclosure may include: detecting temperature of an SCR catalyst purifying an exhaust gas; comparing the temperature of the SCR catalyst to an activation temperature; and controlling control parameters of a common rail engine according to the temperature of the SCR catalyst.

The controlling control parameters may include: entering a catalyst activation combustion mode when the temperature of the SCR catalyst is greater than or equal to the activation temperature; and entering a catalyst deactivation combustion mode when the temperature of the SCR catalyst is less than the activation temperature.

When the catalyst activation combustion mode is entered, timing of fuel injection into the combustion chamber may be advanced, pressure of a common rail of the common rail engine may be increased, and a recirculation amount of the exhaust gas by the EGR apparatus may be decreased.

When the catalyst deactivation combustion mode is entered, timing of fuel injection into the combustion chamber may be retarded, pressure of a common rail of the common rail engine may be decreased, and a recirculation amount of the exhaust gas by the EGR apparatus may be increased.

According to an exemplary embodiment of the present disclosure, it is possible to improve fuel consumption of the vehicle and reduce an amount of exhaust gas, such as nitrogen oxide, by adjusting control parameters of an engine according to temperature of a catalyst of an exhaust gas post-processing unit.

Further, fuel consumption can be reduced by entering a catalyst activation combustion mode when temperature of an SCR catalyst is greater than or equal to an activation temperature, and an amount of exhaust gas, such as nitrogen oxide, can be decreased by entering a catalyst deactivation combustion mode when temperature of the SCR catalyst is less than an activation temperature.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

The drawings are provided to be referred to in explaining exemplary embodiments of the present disclosure, and the spirit of the present disclosure should not be construed as limited to the accompanying drawings.

FIG. 1 is a schematic view illustrating an apparatus for controlling an engine of a vehicle according to an exemplary embodiment of the present disclosure;

FIG. 2 is a schematic view illustrating a common rail engine according to an exemplary embodiment of the present disclosure;

FIG. 3 is a block diagram illustrating an apparatus for controlling an engine of a vehicle according to an exemplary embodiment of the present disclosure; and

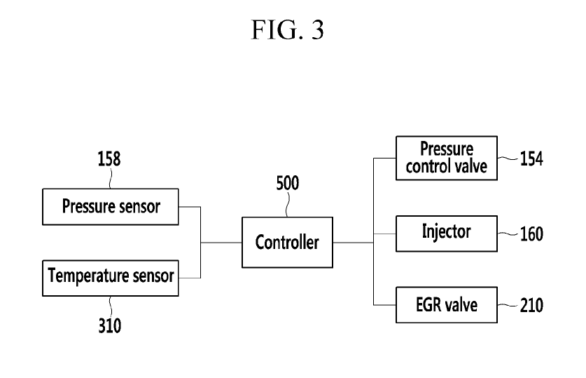

FIG. 4 is a flowchart illustrating a method for controlling an engine of a vehicle according to an exemplary embodiment of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As those skilled in the art would realize, the described embodiments may be modified in various different ways, all without departing from the spirit or scope of the present disclosure.

In addition, the size and thickness of each configuration shown in the drawings are arbitrarily shown for better understanding and ease of description, but the present disclosure is not limited thereto. In the drawings, the thickness of layers, films, panels, regions, etc., are exaggerated for clarity.

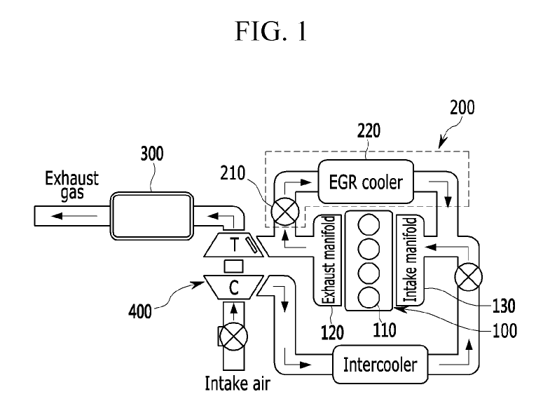

FIG. 1 is a schematic view illustrating an apparatus for controlling an engine of a vehicle according to an exemplary embodiment of the present disclosure.

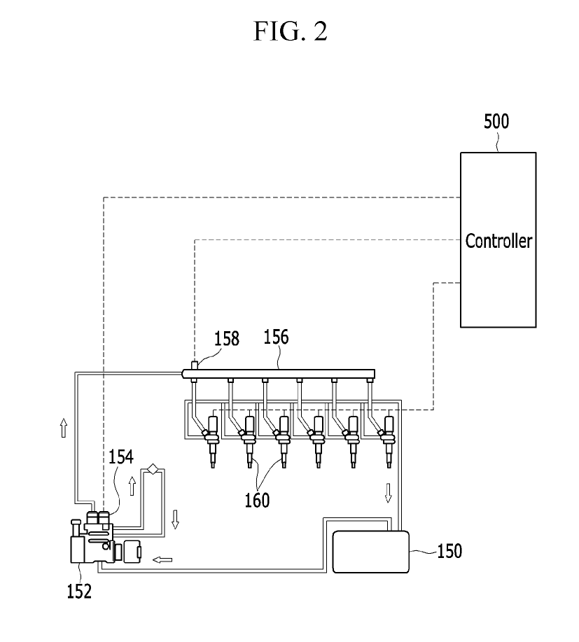

As illustrated in FIG. 1, an apparatus for controlling an engine of a vehicle according to an exemplary embodiment of the present disclosure includes a common rail engine 100 having a plurality of combustion chambers 110 and supplying driving torque by combustion of fuel injected to the combustion chambers 110, an EGR apparatus 200 supplying exhaust gas to the combustion chamber 110 by recirculating a part of exhaust gas exhausted from the combustion chambers 110, an SCR catalyst 300 disposed at an exhaust pipe and purifying the exhaust gas exhausted from the combustion chamber 110, and a controller 500 in FIG. 2 controlling parameters of the common rail engine 100 according to temperature of the SCR catalyst 300.

The common rail engine 100 is run by a scheme that directly injects fuel into a combustion chamber 110, unlike an existing engine which is run by a scheme that supplies fuel and air to the combustion chamber 110 through a mixer.

For example, a diesel fuel injecting device which has been used up to now is run by a scheme that uses a cam driving device in order to acquire injection pressure and has a principle in which the injection pressure increases together with an increase of velocity, and as a result, an injection fuel amount increases.

However, a common rail scheme according to the present disclosure has an advantage in that generation of injection pressure and an injection process are separated from each other such that pressure generation and injection of fuel may be separately considered when designing an engine, and as a result, combustion and injection processes may be freely designed.

That is, in the common rail diesel engine, since fuel pressure and a fuel injection time may be adjusted according to an engine operating condition by using an engine map, even when an rpm of the engine is low, high-pressure injection is enabled, and as a result, complete combustion may be pursued, exhaust and noise may be reduced, and fuel efficiency may be significantly improved.

Referring to FIG. 2, according to the common rail engine 100, fuel in a fuel tank 150 is pumped by a high-pressure fuel pump 152 and supplied to a common rail 156. Fuel which is supplied to the common rail 156 while maintaining predetermined pressure is injected into the combustion chamber 110 by a fuel injector 160.

The high pressure fuel pump 152 serves to pump fuel while being driven by a cam shaft (not illustrated), and pressure in the common rail 156 is detected by a pressure sensor 158.

The controller 500 controls a pressure control valve 154, which is disposed in an outlet of the high pressure fuel pump 152 according to the rpm and a load of the engine, so as to continuously control fuel to a set value without compressing the fuel at a high pressure while rotating the engine.

Referring to FIG. 1, the EGR apparatus 200 extracts exhaust gas from the front end of a turbocharger 400 supplying turbocharged air to the engine, and recirculates the exhaust gas to the engine. It will be recognized by the skilled artisan that the exhaust gas may also be captured at other points for recirculation. The EGR apparatus 200 includes an EGR valve 210 adjusting a recirculation amount of the exhaust gas, and an EGR cooler 220 cooling the exhaust gas having a high temperature recirculated by the EGR valve 210. The exhausted gas is flowed into the engine through an intake manifold 130.

The SCR catalyst 300 is used to purify noxious materials such as hydrocarbons (HC), carbon monoxide (CO), and nitrogen oxides (NOx) from the exhaust gas generated by the engine. The SCR catalyst 300 induces an oxidation reaction of hydrocarbons, carbon monoxide, and a reduction reaction of nitrogen oxide by impregnating precious metals including platinum, palladium, and rhodium with aluminum as a base.

The catalyst has a purifying ability that increases as the temperature increases. When the catalyst does not reach an activation temperature, the ability to purify noxious materials decreases, so it cannot oxidize or reduce noxious materials but allows these materials to be discharged to the atmosphere, and accordingly, emissions may be deteriorated.

In order to solve the above problems, the controller 500 controls the control parameters of the common rail engine 100 according to temperature of the SCR catalyst 300. The temperature of the SCR catalyst 300 is detected by a temperature sensor 310.

The controller 500 can be realized by one or more processors activated by a predetermined program, and the predetermined program can be programmed to perform each step of a method for controlling an engine of a vehicle according to an embodiment of this invention.

The control parameters of the common rail engine may include timing of fuel injection into the combustion chamber 110, pressure of the common rail 156, and recirculation amount of the exhaust gas.

In detail, the controller 500 enters a catalyst activation combustion mode when the temperature of the SCR catalyst 300 detected by the temperature sensor 310 is greater than an activation temperature. And when the temperature of the SCR catalyst 300 detected by the temperature sensor 310 is greater than the activation temperature, the controller 500 enters a catalyst deactivation combustion mode.

When the catalyst activation combustion mode is entered, the controller 500 advances the timing of fuel injection into the combustion chamber 110, increases the pressure of the common rail 156, and decreases recirculation amount of the exhaust gas by the EGR apparatus 200.

The fuel injection timing is adjusted through the injector 160. The pressure of the common rail 156 is adjusted by controlling opening of the pressure control valve 154. The recirculation amount of the exhaust gas is adjusted by controlling opening of the EGR valve.

Since a purification rate of the exhaust gas by the SCR catalyst 300 is high when the temperature of the SCR catalyst 300 is greater than the activation temperature, the controller 500 performs the catalyst activation combustion mode in order to reduce fuel consumption of the vehicle.

When the catalyst deactivation combustion mode is entered, the controller 500 retards the timing of fuel injection into the combustion chamber 110, decreases pressure of the common rail 156, and increases recirculation amount of the exhaust gas by the EGR apparatus 200.

Since the purification rate of the exhaust gas by the SCR catalyst 300 is low when the temperature of the SCR catalyst 300 is less than the activation temperature, the controller 500 performs the catalyst deactivation combustion mode that decreases an amount of exhaust gas such as nitrogen oxide.

Hereinafter, a method for controlling an engine of a vehicle according to an exemplary embodiment of the present disclosure will be described in detail with reference to accompanying drawings.

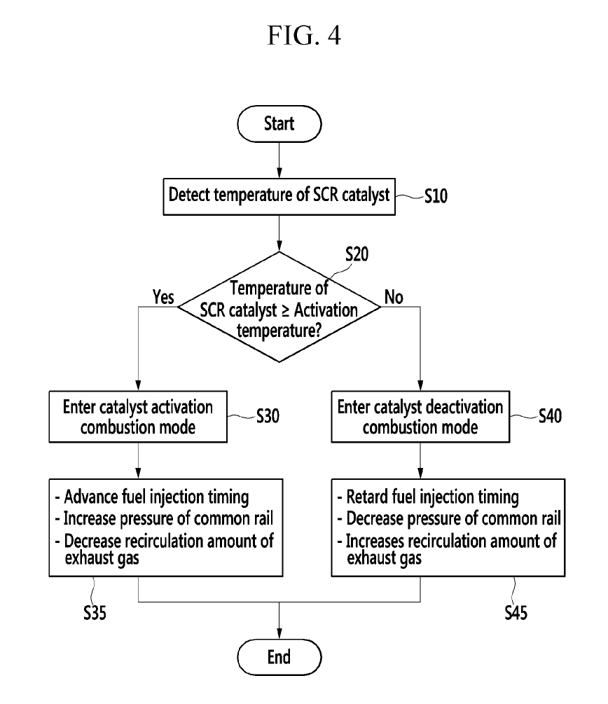

FIG. 4 is a flowchart illustrating a method for controlling an engine of a vehicle according to an exemplary embodiment of the present disclosure.

As shown in FIG. 4, the temperature sensor 310 detects the temperature of the SCR catalyst 300 purifying the exhaust gas at step S10. The temperature sensor 310 detected by the temperature sensor 310 is supplied to the controller 500.

The controller 500 compares the temperature of the SCR catalyst to the activation temperature at step S20.

When the temperature of the SCR catalyst is greater than or equal to the activation temperature, the controller 500 enters the catalyst activation combustion mode at step S30. When the temperature of the SCR catalyst is less than the activation temperature, the controller 500 enters the catalyst deactivation combustion mode at step S40.

When the catalyst activation combustion mode is entered at step S30, the controller 500 advances the timing of fuel injection into the combustion chamber 110, increases the pressure of the common rail 156, and decreases recirculation amount of the exhaust gas by the EGR apparatus 200 at step S35.

When the catalyst deactivation combustion mode is entered at step S40, the controller 500 retards the timing of fuel injection into the combustion chamber 110, decreases pressure of the common rail 156, and increases recirculation amount of the exhaust gas by the EGR apparatus 200 at step S45.

As described above, according to an exemplary embodiment of the present disclosure, it is possible to improve fuel consumption of the vehicle and reduce an amount of exhaust gas, such as nitrogen oxide, by adjusting the control parameters of the common rail engine 100 according to the temperature of the SCR catalyst 300.

### DESCRIPTION OF SYMBOLS

100: common rail engine

110: combustion chamber

130: intake manifold

150: fuel tank

152: high pressure fuel pump

154: pressure control valve

156: common rail

158: pressure sensor

160: injector

200: EGR APPARATUS

210: EGR valve

220: EGR cooler

300: SCR catalyst

310: temperature sensor

400: turbocharger

500: controller

While this invention has been described in connection with what is presently considered to be practical exemplary embodiments, it is to be understood that the invention is intended to cover various modifications and equivalent arrangements included within the spirit and scope of the appended claims.

What is claimed is:

1. An apparatus for controlling an engine of a vehicle, comprising:
a common rail engine having a plurality of combustion chambers, and supplying driving torque by combustion of fuel injected to the combustion chambers;
an EGR apparatus supplying exhaust gas to the combustion chambers by recirculating a part of exhaust gas exhausted from the combustion chambers;
an SCR catalyst disposed at an exhaust pipe and configured to purify the exhaust gas exhausted from the combustion chambers; and
a controller controlling control parameters of the common rail engine according to a temperature of the SCR catalyst.

2. The apparatus according to claim 1, wherein
the controller is configured to enter a catalyst activation combustion mode when the temperature of the SCR catalyst is greater than or equal to an activation temperature, and
enters a catalyst deactivation combustion mode when the temperature of the SCR catalyst is less than the activation temperature.

3. The apparatus according to claim 2, wherein when the catalyst activation combustion mode is entered, the controller is configured to advance timing of fuel injection into the combustion chamber, increase a pressure of a common rail of the common rail engine, and decrease a recirculation amount of the exhaust gas by the EGR apparatus.

4. The apparatus according to claim 2, wherein when the catalyst deactivation combustion mode is entered, the controller is configured to retard timing of fuel injection injected into the combustion chamber, decrease a pressure of a common rail of the common rail engine, and increase recirculation amount of the exhaust gas by the EGR apparatus.

5. A method for controlling an engine of a vehicle comprising:
detecting by at least one temperature sensor a temperature of an SCR catalyst purifying an exhaust gas;
comparing by a controller the temperature of the SCR catalyst to an activation temperature; and
controlling by the controller control parameters of a common rail engine according to the temperature of the SCR catalyst.

6. The method according to claim 5, wherein the controlling of control parameters comprises:
entering a catalyst activation combustion mode when the temperature of the SCR catalyst is greater than or equal to the activation temperature; and
entering a catalyst deactivation combustion mode when the temperature of the SCR catalyst is less than the activation temperature.

7. The method according to claim 6, wherein when the catalyst activation combustion mode is entered, a timing of fuel injection into the combustion chamber is advanced, a pressure of a common rail of the common rail engine is increased, and recirculation amount of the exhaust gas by the EGR apparatus is decreased.

8. The method according to claim 6, wherein when the catalyst deactivation combustion mode is entered, a timing of fuel injection into the combustion chamber is retarded, a pressure of a common rail of the common rail engine is decreased, and a recirculation amount of the exhaust gas by the EGR apparatus is increased.
